(19) United States
(12) Patent Application Publication
(10) Pub. No.: US 2001/0032185 A1
(43) Pub. Date: Oct. 18, 2001

(54) Providing pay services over a network

(76) Inventor: Kazunori Masaki, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/832,921

(22) Filed: Apr. 12, 2001

(30) Foreign Application Priority Data
Apr. 14, 2000 (JP) 113973/2000
Mar. 2, 2001 (JP) 58926/2001

(51) Int. Cl. G06F 17/60

(52) U.S. Cl. 705/52

(57) ABSTRACT

In submitting a request to provide pay services over a network, such as printing a print job, a user designates a basic setting for the print job and enters an upper limit of a charge to be subjected to accounting (i.e, an upper limit of an amount he will pay for the requested services). An accounting server utilizes the setting information to determine which services can be provided within the upper limit and submits the determined services to the user for the user to select. The accounting server may also determine additional services that can be provided, either within the upper limit or above the upper limit, and submits them to the user as well. The user selects one of the basic setting or the additional services determined by the accounting server, whereby the print job is submitted to a service provider and the service is executed.

### BACKGROUND OF THE INVENTION

1. Field of the Invention

The present invention relates to providing services for pay over a network. More particularly, the present invention relates to submitting a request for services that require payment of a charge over a network to a service provider, whereby a determination is made what services can be provided within a payable charge limit.

2. Description of the Related Art

In conventional systems that provide print for pay services over a network, a preset menu of available services and the charges associated therewith are predetermined and set by the service provider. Conventionally, a user can only select an item from the service menu set by the service provider. As such, the options available to the user are limited to those listed in the preset menu and, when the user wants to select a service that is not provided in the preset menu, the user is compelled to compromise and select only one or more of the available options.

Moreover, the user may have a limited budget or spending limit for their service request. In this case, if the user submits their service request to the service provider without knowing what the cost of the requested services are in advance, they may exceed their spending limit. That is, where the user has a set spending limit, he generally does not know in advance which services to request that will keep the cost within his spending limit. As a result, the user may either have to deselect different services in order to remain within their fixed limit or will have to forego requesting service altogether.

Further, if the user requests services that are within his spending limit, he may not know what additional services are available that he can request and still remain within his limited budget. As such, although additional services may be available, the user may bypass these services since he may not be aware of the additional services that can be provided within his spending limit.

### SUMMARY OF THE INVENTION

The present invention addresses the foregoing problems and it is an object of the present invention to make it possible to provide more optimal services that match a user's need. Another object of the present invention is to inform a user of the contents of possible pay services other than those requested by the user that are provided within or beyond the upper limit of a payable charge. Another object of the present invention is to inform a user of the contents of services, which are provided without the necessity of paying an extra charge, or the contents of services which require payment of an extra charge, according to the charge for a basic service. Yet another object of the present invention is to inform a user of services that can be provided within an upper spending limit. Still another object of the present invention is to make it possible to provide a more optimal service request that matches a user's need by including a negotiation step, which is initiated with a user's action of setting an upper spending limit, as a step to be performed in the vicinity of a so-called post-processing step of accounting.

Accordingly, in one aspect the invention provides pay services over a network by detecting a request for a designated pay service and an upper limit of an amount to be paid for the designated pay service, and outputting information that represents a pay service other than the designated pay service which can be provided within the upper limit of the amount to be paid.

In another aspect, the invention provides pay services over a network by judging a charge for a basic service, and outputting information which represents a service that can be provided within a payable limit without payment of a charge that will exceed the payable limit according to the judged charge for the basic service.

In another aspect, the invention provides a pay service over a network by detecting a request for a designated service and an upper limit of a payable amount for the designated service, and outputting information that represents a pay service other than the designated service which can be provided beyond the upper limit of payable amount.

In yet another aspect, the invention provides a pay service over a network by judging a charge for a basic service, and outputting information which represents a service that requires payment of an extra charge beyond an upper limit of a payable amount according to the judged charge for the basic service.

In yet a further aspect, the invention presents options for a pay service by detecting a setting that requires payment of charge, and presenting an option that requires payment of a charge larger than the detected setting and that falls within an upper limit of a payable charge.

In yet a further aspect, the invention is an accounting system having a service providing apparatus, a data processing apparatus, and an accounting apparatus, the accounting system comprising input means for inputting an upper limit of a charge payable for a requested service, determining means for determining candidates for a service which can be provided by the service providing apparatus within an upper limit of the charge, and reporting means for reporting information of the candidates to the data processing apparatus.

In yet a further aspect, the invention performs accounting on provision of a predetermined service by acquiring an upper limit of a charge that is entered by a user, determining candidates for a service that can be provided within the upper limit of the charge, and outputting information of the determined candidates.

Further objects, features and advantages of the present invention will become apparent from the following description of the preferred embodiments with reference to the attached drawings.

### BRIEF DESCRIPTION OF THE DRAWINGS

FIG. 1 shows the outline of an accounting system in which the present invention may be implemented.

FIG. 2 shows the configuration of a host computer.

FIG. 3 shows the configuration of an accounting server.

FIG. 4 is a flowchart describing processing performed in one embodiment of the invention.

FIG. 5 shows an example of a user interface for prompting a user to enter an upper spending limit.

FIG. 6 shows an example of a user interface for indicating available service options and prompting a user to select any of the options.

FIG. 7 is a flowchart describing processing performed in an example of the present embodiment.

FIG. 8 shows an example of a user interface for prompting a user to enter an upper spending limit.

FIG. 9 shows an example of a user interface for prompting a user to designate priority levels for a setting for printing.

FIG. 10 shows an example of a user interface for indicating available services and prompting a user to select any of the services.

### DESCRIPTION OF THE PREFERRED EMBODIMENTS

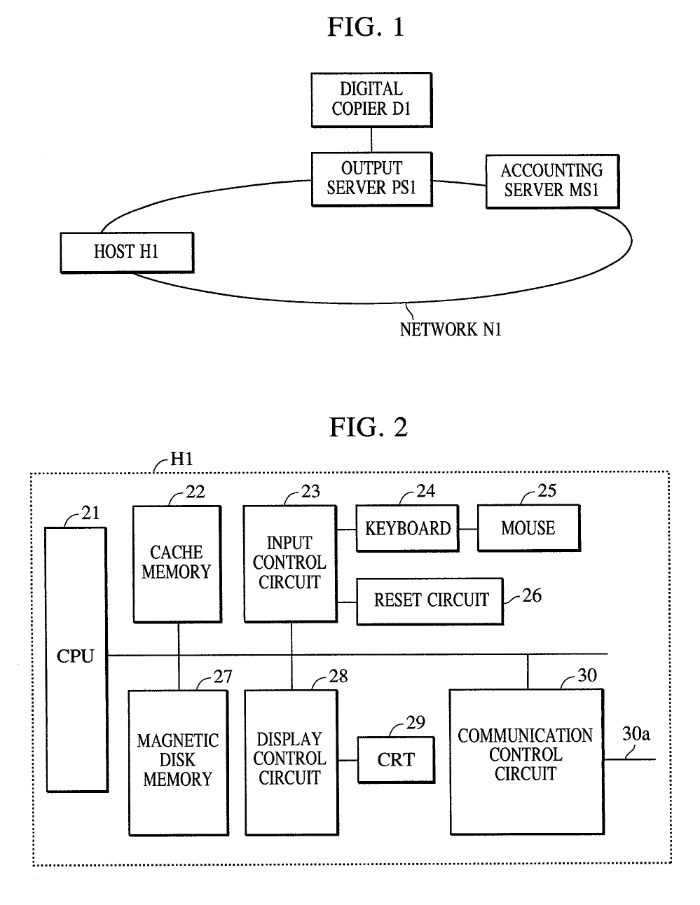

FIG. 1 shows an example of the configuration of a system which provides a print for pay service in which the present invention may be implemented. As seen in FIG. 1, the system preferably includes at least one host computer H1, a print server PS1, and an accounting server MS1 that are interconnected with each other via a network N1. The print server PS1 and the accounting server MS1 are preferably maintained by a service provider, such as a print shop, that receives requests for processing a print job for pay. However, the print server PS1 and the accounting server MS1 could also be maintained by a separate entity with the print request being submitted to and processed by a print shop separate from the entity. The system may also include a digital copier D1 that is an output apparatus that is locally connected to the print server PS1. Although FIG. 1 depicts only one host computer H1 and one print server PS1 connected via the network N1, it can readily be understood that a plurality of host computers and print servers may be connected to the network N1. However, for the sake of brevity, FIG. 1 only depicts one host computer and one print server. Additionally, it can readily be understood that a plurality of accounting servers may be connected to the network for the purpose of distributed processing or the like.

In FIG. 1, the digital copier D1 is depicted as being connected locally, i.e. directly, to the print server PS1. Of course, the invention is not limited to a system having a digital copier connected locally to the print server and any other type of output apparatus (service providing apparatus) may be implemented. In addition, the infrastructure of the network preferably includes a model 10/100 BaseTx but is not limited to any specific model. Hereinafter, the network and infrastructure are generically described as the network. It can also be readily understood that the print server PS1 and the accounting server MS1 are not required to be separate servers per se and may be integrated with each other into a single server.

Host computer H1 may be any type of computer that provides the ability to access a service provider and submit a print for pay request via a network. In this regard, host computer H1 may be a desktop computer implementing a windows operating system, or any other type of computer workstation and operating system. Host computer H1 preferably includes a keyboard and a mouse, or any other device that enables a user to designate a setting in a user interface, as well as a display or a loudspeaker, or the like that provides a user with information. The servers PS1 and MS1 and the host Hi may be connected via serial cables, a public network, or a wireless network. The topology has no significant meaning to the present invention.

FIG. 2 shows a general configuration of the host computer H1. A CPU 21 controls processing in the host computer. Data or application software programs are generally stored in a cache memory 22 that is a fast access memory. A keyboard 24 is used to enter data and commands for the purpose of editing text or developing a program. A mouse 25 is used to select an icon displayed on a screen of a cathode-ray tube (hereinafter CRT) 29 serving as a display device. Herein, the keyboard 24 and mouse 25 are adopted as information input units. Alternatively, a touch panel display, a microphone, and an optical character reader (OCR) that provide the same advantages as the keyboard and mouse may be adopted instead as long as they serve as a means that enables a user to enter information.

A reset circuit 26 generates a signal which resets the CPU 21 or any application software program (such as an operating system) that is initialized when the main power supply is turned on. The reset signal may be initiated when the CPU 21 or an application software program is installed in a main unit of the host computer, or when a Reset button is pressed. The Reset button may be a switch included in the keyboard 24, for example, a Stop key, or a main Reset button of the host computer. An input control circuit 23 transfers a signal input from the keyboard 24, mouse 25, or reset circuit 26 to the CPU 21.

A magnetic disk memory 27 serves as a large-capacity memory in which application software programs are mainly stored. A CRT 29 displays information on a screen. A display control circuit 28 develops display data into pixel data so that the display data sent from the CPU 21 can be displayed on the CRT 29, and thus produces a video data signal. Alternatively, the CRT 29 may be a liquid crystal display device. Herein, the CRT 29 is adopted as an information reporting apparatus, that is, the preferred method of providing a user with information. However, a loudspeaker capable of providing the same advantages as the CRT may be adopted (for reporting by voice).

A communication control unit 30 connects the host computer to the servers PS1 and MS1 over the network N1. The communication control unit 30 transmits and receives data to and from various pieces of equipment (servers PS1 and MS1) under the control of a network operating system. An interface 30a is coupled to the network N1. The CPU 21 accesses the memories 22 and 27 and the CRT 29 directly over a data bus or indirectly via a control circuit. Hereinafter, the keyboard 24, mouse 25, and CRT 29 are hardware serving as a user interface. When a plurality of host computers is interconnected over a network, the host computers may not have the same configuration as one another. If different addresses are assigned to the host computers on the network, two host computers can be activated simultaneously.

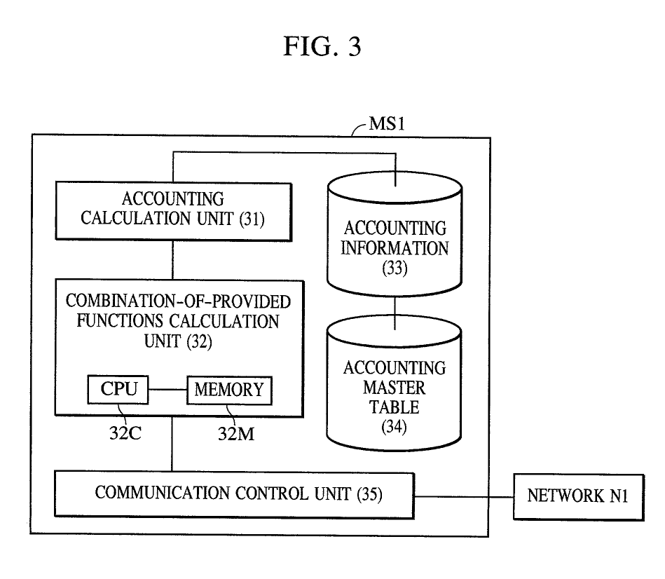

FIG. 3 shows the configuration of the accounting server MS1. The accounting server MS1 may be any type of server, such as a Compaq Prosignia server, but need not be a server per se. Rather, accounting server MS1 merely provides the functionality of a server by supporting server software that provides for interaction between the accounting server MS1 and other devices on the network N1. For specific functionality relating to the present invention however, accounting server MS1 preferably includes of an accounting calculation unit 31, a combination-of-provided functions calculation unit 32, an accounting information memory 33, an accounting master table 34, and a communication control unit 35. The accounting server MS1 also includes other fundamental components of a server which are well known in the art and which are not depicted herein for the sake of brevity.

The accounting calculation unit 31 calculates a charge, which is subjected to accounting, according to an input service request submitted by a user for outputting by the service provider. The accounting master table 34 maintains a table of charges and associated services for each service request type that is provided by the service provider that is to process the service request. For calculating the charge, price data of each service recorded in the accounting master table 34 is used by the accounting calculation unit 31.

The combination-of-provided functions calculation unit 32 includes a CPU 32C and a memory 32M. The CPU 32C is preferably a microcomputer and the memory 32M is preferably a recording medium in which an action program instructing the CPU 32C to perform actions is stored. Accounting information memory 33 is stores accounting information of users. Herein, the accounting calculation unit 31 and combination-of-provided functions calculation unit 32 are separate from one another, but alternatively, they may be integrated in a single unit. When the accounting calculation unit 31 and 10 combination-of-provided functions calculation unit 32 are integrated in a single unit, the CPU 32C and memory 32M realize the capabilities of the accounting calculation unit and combination-of-provided functions calculation unit 32.

The combination-of-provided functions calculation unit 32 generates a listing of service request options. The listing is generated utilizing an upper limit charge input by a user and the costs of the requested services contained in the accounting master table 34. The combination-of-provided functions calculation unit 32 references the accounting master table 34 to obtain the requested services and their associated costs, and checks a result of a calculation performed by the accounting calculation unit 31 to generate the listing.

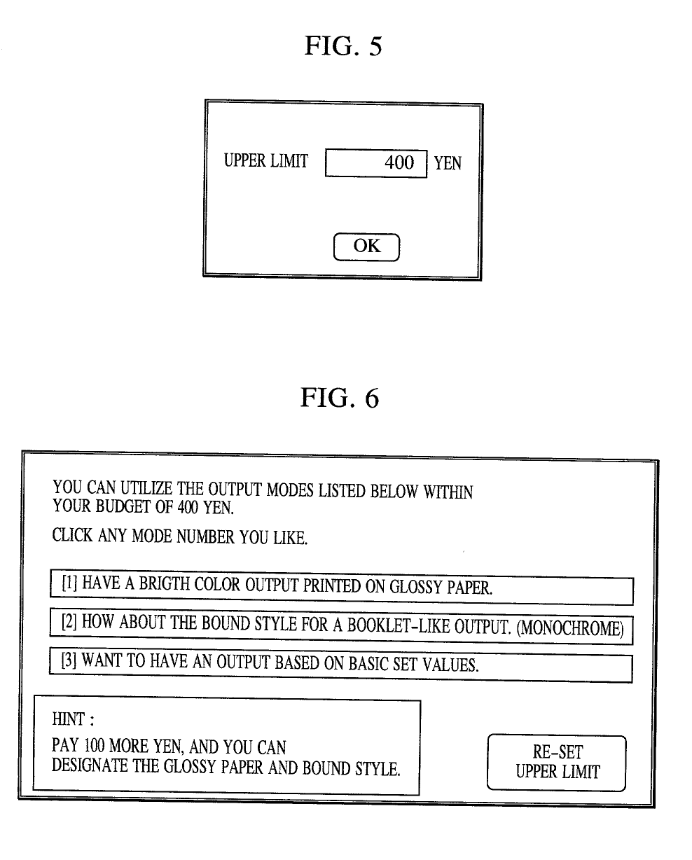

In more detail, and as will be described in more detail below, a user inputs an upper limit charge that they want to pay for having various services rendered by the service provider. For example, as seen in FIG. 5, the user may enter an upper limit charge amount of 400 yen. The user may also input various service requests options. For instance, the user may request a number of copies of a document to be printed, whether the copies are to be color, black and white or photo, a type of paper for printing each copy (e.g. plain paper, high grade paper, glossy photo paper, etc.), and various finishing options (e.g. binding). Upon receiving the upper limit data and the requested service options input by the user, the accounting server MS1 accesses accounting master table 34 and utilizing the input data, the accounting calculation unit 31 determines if the requested services fall within the upper limit. If not, the combination-of-provided functions calculation unit 32 determines various combinations of the requested services that fall within the upper limit and generates a listing of the combinations.

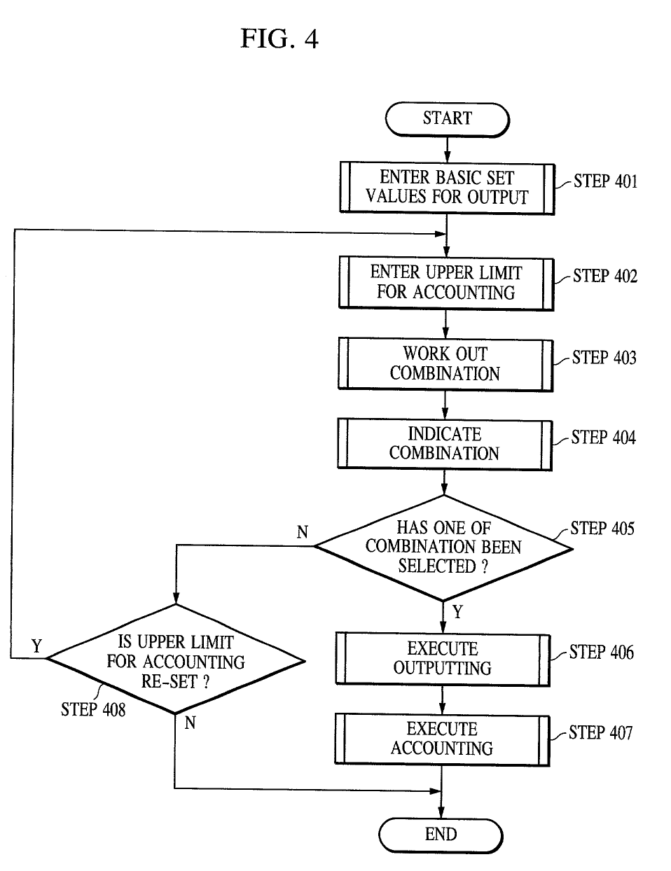

Next, the flow of processing in accordance with the present embodiment will be described below in conjunction with the flowchart of FIG. 4.

In FIG. 4, at step S401, the user activates an application program for submitting a print job for pay over a network. Upon activating the application program, a window is displayed on CRT 29 for the user to input information for submitting the print job for pay over the network. In step S401, the user inputs basic setting information (service request options) at host computer H1 using the keyboard 24 or mouse 25. The basic setting is specified with set items, such as a designated file of an original to be processed, a designated number of copies, and designation of a color output or a monochrome (black and white) output. As the original file, an original file stored in the cache memory 22 in the host computer H1 may be designated, or an original file stored in any other piece of equipment connected over the network N1 may be designated. The set items to be designated may further include candidates for a combination of functions to be presented at step S404 that will be described later. For example, the set items may include a paper size, a paper type (plain paper, glossy paper, projector sheets, etc.), designation of a monochrome output, designation of a color output, and designation of a bound style.

Once the user has input the basic settings in step S401, in step S402, the user is prompted to enter an upper limit of a charge to be subjected to accounting (the upper limit of a payable charge) via a user interface such as that shown in FIG. 5. In the example shown in FIG. 5, the user has entered 400 yen as the upper limit of a payable charge using the keyboard 24. Once the user enters the upper limit information, he selects an OK button in the user interface (keyboard 24), whereby control passes to step S403.

In the example shown in FIG. 5, the user is prompted to enter the upper limit of a charge to be subjected to accounting by entering text. Alternatively, a still image, a motion picture, or voice may be utilized in place of text to enter the upper limit. Additionally, instead of entering the upper limit of a payable charge, a balance in a prepaid card may be detected and adopted as the upper limit. When the prepaid card is adopted, a prepaid card reader/writer is connected to the input/output control circuit 23 of the host computer H1. The balance in the prepaid card inserted into the prepaid card reader/writer is detected and is set as the upper limit.

At step S403, the combination-of-provided functions calculation unit 32 works out an optimal combination of services that can be provided within the upper limit of the payable charge the user has entered at the host computer H1 at step S402. In other words, candidates for a combination of functions that produces a highly sophisticated output (candidates for a setting for output processing) are determined. As described in relation to the configuration of the accounting server MS1, optimal settings are listed by referencing the accounting master table 34 and checking a result of a calculation performed by the accounting calculation unit 31.

In the accounting master table 34, a price at which one monochrome output is printed on plain paper, a price at which one color output is printed on glossy paper, and a price at which an output is printed and bound are stored. Based on the prices and a user-designated number of original files, and a user-designated number of copies, the accounting calculation unit 31 calculates a charge for the processing based on the user-designated setting, a charge for a color output printed on glossy paper, a charge for a bound monochrome output, or a charge for a bound color output. The CPU 32C determines which services can be provided within the upper limit of the payable charge entered at step S402 (without the necessity of paying an extra charge) according to the basic setting designated at step S401 and the price recorded in the accounting master table 34. The CPU 32C then reports the determined services to the host computer H1. A program based on which the CPU 32C executes the processing is stored in the memory 32M. At step S403, the CPU 32C determines optional services that require payment of a larger charge than the charge for the printing services entered at step S401, and that can be provided within the upper limit of the payable charge entered at step S402.

In step S404, the candidates for additional services that can be rendered and not exceed the upper limit of a payable charge are presented in a user interface (CRT 29). In the example shown in FIG. 6, three candidates for additional services are presented. The candidates for additional services include [1] a setting in which a color output is printed on glossy paper, [2] a setting in which a monochrome output is printed in a bound style, and [3] a setting in which an output is printed based on the basic setting. The basic setting adopted as the candidate [3] is the basic setting designated at step S401. Herein, monochrome printing has been designated at step S401. However, if a color output can be printed on glossy paper within the upper limit of the payable charge entered at step S402, the combination-of-provided functions calculation unit 32 indicates this as an additional service as the candidate [1]. If a monochrome output can be printed and bound, this additional service is presented as the candidate [2]. If a user finds that any of the candidates for a service presented in the user interface is to his liking, the user selects that candidate. In the example shown in FIG. 6, if the user desires to have candidates [1] and [2] performed, the user clicks and selects the candidate [1] or [2] using the mouse 25. If on the other hand the user merely desires the basic setting entered initially at step S401, the user clicks and selects the candidate [3].

At step S404, a hint field may be defined as shown in FIG. 6, and a hint indicating that if a user pays an additional amount the user can designate additional services to be performed. For example, as shown in FIG. 6, the hint may indicate that if the user pays an additional one hundred yen, the user can designate the glossy paper and bound style. In other words, the combination-of-provided functions calculation unit 32 reports to the host computer H1 an example of a service that can be provided over the upper limit of the payable charge. A program based on which the CPU 32C performs the processing is stored in the memory 32M.

In this example, if a color output can be printed on glossy paper and bound with payment of an additional one hundred yen over the upper limit of the payable charge entered at step S402, this information is presented in the hint field on the CRT 29. Accordingly, the user may check the information presented in the hint field and re-enter the upper limit of the payable charge. If a Re-set Upper Limit button has been selected by clicking the mouse 25 (step S408), control is returned to step S402. In this case, the user interface shown in FIG. 5 appears again to prompt the user to enter the upper limit of the payable charge. Incidentally, if the upper limit of a payable charge has been set based on the balance in a prepaid card, cash may be injected or a new prepaid card with a higher credit amount may be inserted. Thereafter, the upper limit of the payable charge may be re-set. If the user has selected any setting for services at step S405, control is returned to step S406.

At step S406, the accounting server MS1 submits the information the user-selected for outputting to output server PS1. At this time, if output server PS1 can realize the services, output server processes the information to submit it to a device for output processing. For example, if the user has selected the candidate [2] shown in FIG. 6, this information is submitted to the output server PS1. If output server PS1 can perform the requested services, it outputs the information to an output apparatus (digital copier D1, etc.) that is capable of printing and processing a bound style. Thus, in response to the receiving the original file to be printed from host computer H1 and the user-selected service information, the output server PS1 executes processing of the print job. When the print job has completed processing, the output server PS1 issues an end report to the accounting server MS1.

In response to outputting the end report sent from the output server PS1, the accounting server MS1 executes accounting according to unique key information, with which a user can be identified, at step S407. An initial accounting is performed such that a charge for the service provided is written in a user information storage area in the accounting information memory 33. The initial accounting may be succeeded by the processing of immediately paying the charge using a cash card or a prepaid card, though this processing is not described in FIG. 4.

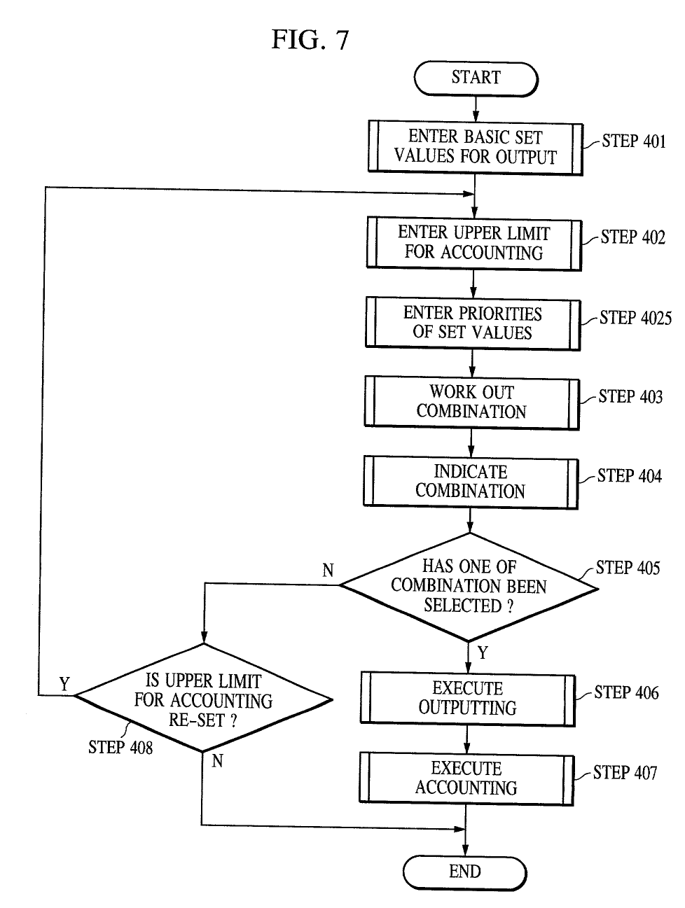

Next, an example in which entering priority levels of the set values (step S4025) is added will be described in conjunction with the flowchart of FIG. 7.

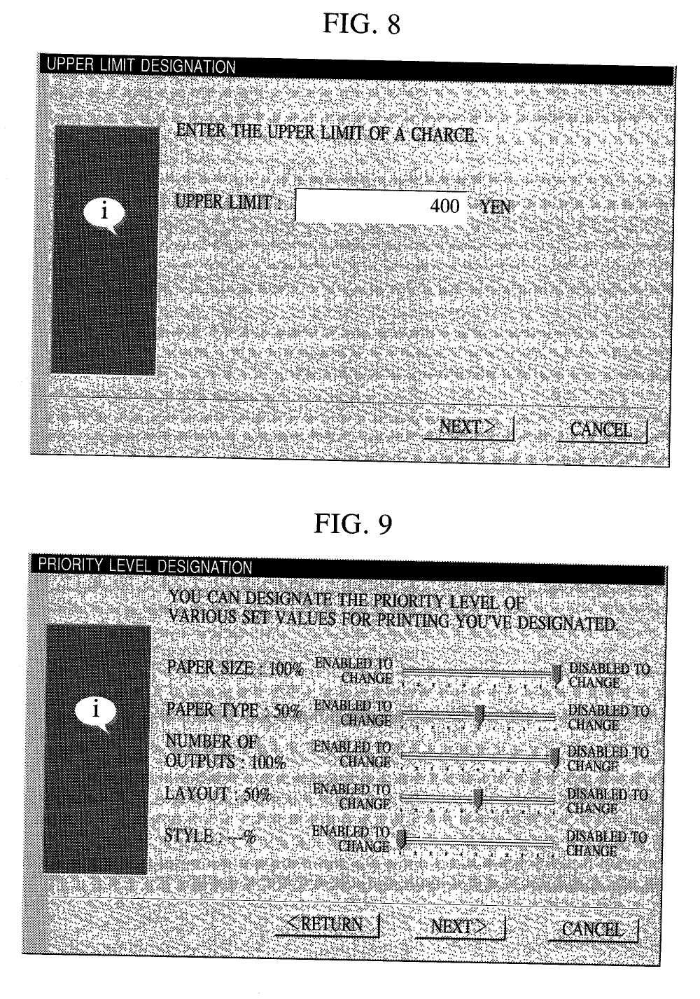

In this example, the combination-of-provided functions calculation unit 32 weights the set parameters (set items) for printing which are entered by a user using user-designated priority levels, together with the user-entered upper limit of a charge to be subjected to accounting (the upper limit of a payable charge). The combination-of-provided functions calculation unit 32 lists the optimal settings for available services by referencing the accounting master table 34 and checking a result of a calculation performed by the accounting calculation unit 31. In this example, after the basic setting for services is designated at step S401 as described in FIG. 4, a user interface (CRT 29) like the one shown in FIG. 8 is used to prompt a user to enter the upper limit of the payable charge. In the example shown in FIG. 8, the user enters 400 yen as the upper limit of the payable charge at the keyboard 24. Like the previous example, the upper limit of the payable charge may be a balance in a prepaid card that is detected and adopted as the upper limit of the payable charge. After the user enters the basic setting information, if a Next button in the user interface is pressed (clicked using the mouse 25), control passes to step S4025. If on the other hand a Cancel button is pressed, control returns to step S401. Also similar to the previous example, in this example, a still image, a motion picture, or voice may be used to prompt a user to enter the upper limit of a payable charge in place of text in a dialog box in CRT 29.

At step S4025, a user interface like the one shown in FIG. 9 is used to prompt the user to designate desired priority levels for the set items that specify the basic setting which have been designated at step S401. The user interface is displayed on the CRT 29 of the host computer H1. In the example shown in FIG. 9, the user has designated 100% “Disabled to change” as the priority level of the set item of a paper size, 50% as the priority level of a paper type, 100% “Disabled to change” as the priority level of the number of outputs (copies), 50% as the priority level of a layout, and “Enabled to change” as the priority of a style. Herein, the set item of the layout specifies a 2 in 1 layout in which an original of two pages is recorded on one sheet of recording paper or a 4-in-1 layout in which an original of four pages is recorded in one sheet of recording paper. In the priority designation form shown in FIG. 9, a priority level for a monochrome output and a color output are not shown but may also be included in the interface of FIG. 9. After setting the priority levels, if the Next button in the user interface is pressed, control passes to step S403.

At step S403, the combination-of-provided functions calculation unit 32 works out an optimal combination of services that can be provided according to the priority levels of the set items designated by the user at step S4025 within the upper limit of a payable charge which has been entered by the user at step S402. In other words, the combination-of-provided functions calculation unit 32 works out candidates for a combination of services (candidates for a setting for outputting) that produces a highly sophisticated output. Herein, optimal settings for services are listed by referencing the accounting master table 34 and checking the result of calculation performed by the accounting calculation unit 31.

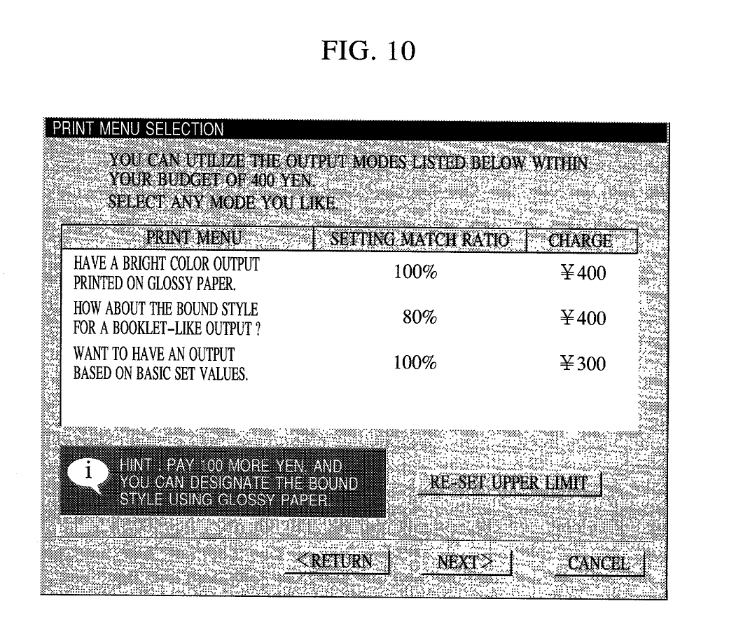

At step S404, the candidates for services are presented in the user interface (CRT 29) according to the user-designated priority levels of the set items within the upper limit of the payable charge which has been worked out at step S403. In the example shown in FIG. 10, three candidates for services are presented. Included as information of each candidate is a comment indicated in a “print menu” field, and a degree by which the priority levels of the set items designated at step S4025 can be satisfied indicated in a “setting match ratio” field. Moreover, a charge for execution of outputting (i.e. rendering the services) is presented in a “charge” field.

As shown in the example of FIG. 10, when the original file designated by the user at step S401 is printed on glossy paper in color, the setting match ratio is 100% and the charge is 400 yen. When the original is to be printed as a monochrome output in a bound style, the setting match ratio is 80% and the charge is 400 yen. When the original is to be output based on the basic setting, the setting match ratio is 100% and the charge is 300 yen. In this example, the combination-of-provided functions calculation unit 32, displays a presentation like the one shown in FIG. 10 on the CRT 29. Note that the setting match ratios filled in the form shown in FIG. 10 are not the setting match ratios determined based on the priority levels designated as shown in FIG. 9. If the user finds that any of the candidates for a setting which are presented in the user interface are to his liking, the user selects the candidate. In the example shown in FIG. 10, the user selects either of the two upper print menus. If the user wants to have the initially entered basic setting processed, the user selects the lowest print menu “Want to have an output based on the basic set values.” The selection is achieved by double-clicking the field in which the candidate for a setting that the user desires is presented by using the mouse 25.

At step S404, a hint may be indicated in the same manner as that describe above in the example shown in FIG. 6. At step S408, similar to that described with reference to FIG. 4, if the Re-set Upper Limit button shown in FIG. 10 is pressed, control returns to step S402.

After the user selects a setting for outputting at step S405, control passes to step S406. At step S406, the accounting server MS1 submits the user-selected information for outputting to the output server PS1. At this time, if the output server PS1 can realize the user-selected setting, it submits the information to an output apparatus that can perform the selected services. For example, if the user has selected the candidate for a setting indicated with “How about the bound style for a booklet-like output?” as shown in FIG. 10, the information of the user-selected setting is submitted to the output server PS1 that controls the output apparatus (digital copier D1, etc.) capable of producing an output in the bound style.

In response to receiving the original file to be output and the user-selected setting information for outputting, the output server PS1 executes the processing by controlling the output apparatus to perform the selected services. When the job is completed, an outputting end report is issued to the accounting server MS1.

In response to the outputting end report issued from the output server PS1, the accounting server MS1 executes accounting based on unique key information, with which the user is identified, similar to that as described above at step S407 in FIG. 7.

A case may arise where it may be judged from the result of calculation performed at step S403 in FIG. 4 or FIG. 7 that there is no combination of services that can be provided within the upper limit of the payable charge entered by the user at step S402. In other words, it may be judged that there is no additional service to be added to a service specified with the basic setting designated at step S401. In this case, the candidates for a setting include only the candidate specified with “Want to have an output based on the basic set values.”

Moreover, it may be judged from the result of the calculation performed at step S403 in FIG. 4 or FIG. 7 that the charge entered at step S401 as one of the set items specifying the basic setting exceeds the upper limit of the payable charge that is entered by the user at step S402. In this case, the candidates for a setting, like those shown in FIG. 6 or FIG. 10, are not presented in the user interface. Instead, a difference of the upper limit from the entered charge is presented in the hint field. The user can then check the information presented in the hint field and reenter the upper limit of the payable charge.

In another example, if the accounting server MS1 judges from the result of the calculation performed at step S403 in FIG.4 or FIG. 7 that the charge entered at step S401 as one of the set items specifying the basic setting exceeds the upper limit of the payable charge which is entered by the user at step S402, services that can be provided within the upper limit of the payable charge are presented. For example, assuming that the bound style is designated at step S401, if an output is not bound, the output may be able to be printed within the upper limit of a payable charge. In this case, at step S404, a message providing that if an output is not bound, the output can be printed is presented. In this case, if the user does not particularly want to have an output bound, a service not combined with the binding service can be selected.

Moreover, discount information or the like may be displayed as a hint presented in the user interface at step S404, though it is not shown in FIG. 6 and FIG. 10. Specifically, a presentation signifying that a discount of a given percentage (X%) will be given for the use of paper having the logo of an output center or a sponsor or an advertisement therefor printed thereon is displayed. The logo or advertisement may be printed on the back of paper or the margin of paper. In this case, when Hint is clicked, the discount is given.

The present invention can be implemented in remote printing to be performed based on an internet printing protocol (IPP) or the like. The IPP is a technology that makes it possible to request that a printer which is installed in a remote place to print over the Internet. An example of an embodiment of the present invention that utilizes the IPP will be described next.

In utilizing IPP, the network N1 is the Internet. A user connects his/her own machine (H1) onto the Internet (N1), and enters a uniform resource locator (URL) assigned to an output service company, thereby connecting to a website of the service company. A home page (web page) of the service company is displayed on a display of the user's machine (H1) and the user selects a web output service in the home page. The company that operates an output service website may have satellite output centers (PS1) in various regions in which various pieces of output equipment (digital copier D1, etc.) are installed. The output service website provides an output service that covers reception of a user's request for outputting, actual outputting, and distribution of the completed product. The user, staying at home, designates a basic setting for outputting (step S401) and enters the upper limit of a payable charge (step S402) through a browser (Internet browsing software). An accounting server (MS1) installed at the service company that operates the output service website processes the basic setting and upper limit (step S403). In this example, the output service website can provide the user with a function to specify a candidate for a type of service setting that is combined with a function for specifying a distribution option (step S404). When the user has designated a setting for outputting (step S405), the company that operates the output service website causes the user's original to be remotely printed based on the user-designated setting at a satellite output center (PS1) located in a region closest to a destination of an output center which the user has designated according to the IPP (step S406). After the output is printed, the accounting server MS1 stores accounting information in a user information storage area (step S407). Alternatively, a settlement service provided by a credit card company may be adopted as a way of paying a charge. The settlement service conforms to the secure electronic transaction (SET) that is an international standard for electronic settlement.

While the foregoing description has been made in consideration of a printing service as an example, the present invention is not limited to a printing service but may be applied to other types of services such as a service for providing image information or the like for a charge through a personal computer, a pay service to be provided through a computer or over a network, or a sale of articles.

The invention may be implemented in a program code of software for realizing the constituent features provided by the aforesaid embodiment and may be installed in a computer included in an apparatus connected to various devices or a computer included in a system so-that the devices can be activated to realize the constituent features. The devices may be activated based on the program being installed in the computer (CPU or MPU) included in the system or apparatus. This apparatus or system is included in the scope of the present invention.

Moreover, while the program code of software realizes the constituent features provided by the aforesaid embodiments, the program code and a means for use in supplying the program code to the computer, such as a recording medium in which the program code is stored, may comprise the constitute features of the present invention. The recording medium in which the program code is stored may be, for example, a floppy disk, a hard disk, an optical disk, a magnetooptical disk, a CD-ROM, a magnetic tape, a nonvolatile memory card, or a read only memory (ROM). The computer executes the supplied program code, whereby the constituent features provided by the foregoing embodiments are realized. In addition, the program code may cooperate with an operating system (OS) executing in the computer or any other application software, whereby the constituent features provided by the foregoing embodiments may be realized. Even in this case, the program code is included in the embodiments of the present invention.

The program code may also be saved in a memory mounted on an extension printed-circuit board incorporated in or connected to the computer, or a memory included in an extension unit. Thereafter, a CPU mounted on the extension printed-circuit board or included in the extension unit may perform any part of or the whole of the actual processing according to the instructions described in the program code. The constituent features provided by the aforesaid embodiment may be realized through the foregoing processing. This case is also included in the scope of the present invention.

The configurations of the components employed in the aforesaid embodiments are mere examples of practical ones in which the present invention may be implemented. However, the technological scope of the present invention should not be limited to the foregoing configurations and it should be readily understood that the present invention can be implemented in various modes without a departure from the spirit or scope of the present invention.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions thereof.

What is claimed is:

1. A method of providing pay services over a network, comprising the steps of:
detecting a request for a designated pay service and an upper limit of an amount to be paid for the designated pay service; and
outputting information that represents a pay service other than the designated pay service which can be provided within the upper limit of the amount to be paid.

2. A method according to claim 1 further comprising a step of requesting provision of one of the designated pay service and the pay service that can be provided within the upper limit.

3. A method according to claim 1, wherein said outputting step includes a step of judging whether a binding service is provided within the upper limit.

4. An apparatus for providing pay services over a network, comprising:
detecting means for detecting a request for a designated pay service and an upper limit of an amount to be paid for the designated pay service; and
output means for outputting information that represents a pay service other than the designated pay service which can be provided within the upper limit of the amount to be paid.

5. An apparatus according to claim 4, further comprising requesting means for requesting provision of one of the designated pay service and the pay service that can be provided within the upper limit.

6. An apparatus according to claim 4, wherein said outputting means includes judging means for judging whether a binding service is provided within the upper limit.

7. A memory medium storing a program therein, the program comprising:
a step of detecting a request for a designated pay service and an upper limit of an amount to be paid for the designated pay service; and
a step of outputting information that represents a pay service other than the designated pay service which can be provided within the upper limit of the amount to be paid.

8. A memory medium according to claim 7, further comprising a step of requesting provision of one of the designated pay service and the pay service that can be provided within the upper limit.

9. A memory medium according to claim 7, wherein said outputting step includes a step of judging whether a binding service is provided within the upper limit.

10. A method of providing pay services over a network, comprising the steps of:
judging a charge for a basic service; and
outputting information which represents a service that can be provided within a payable limit without payment of a charge that will exceed the payable limit according to the judged charge for the basic service.

11. A method according to claim 10 further comprising a step of requesting provision of one of the basic service and the service that can be provided within the payable limit without exceeding the payable limit.

12. An apparatus for providing pay services over a network, comprising:
judging means for judging a charge for a basic service; and
output means for outputting information which represents a service that can be provided within a payable limit without payment of a charge that will exceed the payable limit according to the judged charge for the basic service.

13. An apparatus according to claim 12, further comprising means for requesting provision of one of the basic service and the service that can be provided within the payable limit without exceeding the payable limit.

14. A memory medium storing a program therein, the program comprising:
a step of judging a charge for a basic service; and
a step of outputting information which represents a service that can be provided within a payable limit without payment of a charge that will exceed the payable limit according to the judged charge for the basic service.

15. A memory medium according to claim 14, further comprising a step of requesting provision of one of the basic service and the service that can be provided within the payable limit without exceeding the payable limit.

16. A method of providing a pay service over a network, comprising the steps of:
detecting a request for a designated service and an upper limit of a payable amount for the designated service; and
outputting information that represents a pay service other than the designated service which can be provided beyond the upper limit of payable amount.

17. A method according to claim 16, further comprising a step of requesting provision of one of the designated service and the service that can be provided beyond the upper limit of the payable amount.

18. An apparatus for providing a pay service over a network, comprising:
detecting means for detecting a request for a designated service and an upper limit of a payable amount for the designated service; and
output means for outputting information that represents a pay service other than the designated service which can be provided beyond the upper limit of payable amount.

19. An apparatus according to claim 18, further comprising means for requesting provision of one of the designated service and the service that can be provided beyond the upper limit of the payable amount.

20. A memory medium storing a program therein, the program comprising:
a step of detecting a request for a designated service and an upper limit of a payable amount for the designated service; and
a step of outputting information that represents a pay service other than the designated service which can be provided beyond the upper limit of payable amount.

21. A memory medium according to claim 20, further comprising a step of requesting provision of one of the designated service and the service that can be provided beyond the upper limit of the payable amount.

22. A method of providing a pay service over a network, comprising the steps of:
judging a charge for a basic service; and
outputting information which represents a service that requires payment of an extra charge beyond an upper limit of a payable amount according to the judged charge for the basic service.

23. A method according to claim 22 further comprising the step of requesting provision of one of the basic service and the service that requires payment of the extra charge.

24. An apparatus for providing a pay service over a network, comprising:
judging means for judging a charge for a basic service; and
output means for outputting information which represents a service that requires payment of an extra charge beyond an upper limit of a payable amount according to the judged charge for the basic service.

25. An apparatus according to claim 24 further comprising means for requesting provision of one of the basic service and the service that requires payment of the extra charge.

26. A memory medium storing a program therein, the program comprising:
a step of judging a charge for a basic service; and
a step of outputting information which represents a service that requires payment of an extra charge beyond an upper limit of a payable amount according to the judged charge for the basic service.

27. A memory medium according to claim 26 further comprising a step of requesting provision of one of the basic service and the service that requires payment of the extra charge.

28. An method of presenting options for a pay service, comprising the steps of:
detecting a setting that requires payment of charge; and
presenting an option that requires payment of a charge larger than the detected setting and that falls within an upper limit of a payable charge.

29. A method according to claim 28, further comprising a step of selecting one of the detected setting and the option.

30. A method according to claim 28, wherein at said presenting step, the option is presented according to a charge required by the detected setting.

31. An apparatus for presenting options for a pay service, comprising:
detecting means for detecting a setting that requires payment of a charge; and
option presenting means for presenting an option that requires payment of a charge larger than the detected setting and that falls within an upper limit of a payable charge.

32. An apparatus according to claim 31, further comprising selecting means for selecting one of the detected setting and the option.

33. An apparatus according to claim 31, wherein said presenting means presents the option according to a charge required by the detected setting.

34. A memory medium storing a program therein, the program comprising:
a step of detecting a setting that requires payment of a charge; and
a step of presenting an option that requires payment of a charge larger than the detected setting and that falls within an upper limit of a payable charge.

35. A memory medium according to claim 34, wherein the program further comprises a step of selecting one of the detected setting and the option.

36. A memory medium according to claim 34, wherein at said presenting step, the option is presented according to a charge required by the detected setting.

37. An accounting system having a service providing apparatus, a data processing apparatus, and an accounting apparatus, said accounting system comprising:
input means for inputting an upper limit of a charge payable for a requested service;
determining means for determining candidates for a service which can be provided by said service providing apparatus within an upper limit of the charge; and
reporting means for reporting information of the candidates to said data processing apparatus.

38. An accounting system according to claim 37, wherein said input means inputs priority levels of the requested service and said determining means determines the candidates for a service which can be provided by said service providing apparatus within the upper limit of the charge according to the priority levels.

39. An accounting system according to claim 37, wherein said input means provides an input field on a screen of said data processing apparatus in which the upper limit of the charge is input.

40. An accounting system according to claim 37, wherein said reporting means provides the information of the candidates on a screen of said data processing apparatus so that any of the candidates can be selected.

41. An accounting system according to claim 37, wherein when a charge for a requested service is set by a user and is within the upper limit of the charge, said determining means determines the candidates for the service that can be provided within the upper limit of the charge.

42. An accounting system according to claim 37, wherein the requested service is a service of producing a printout of data.

43. An accounting apparatus for performing accounting on provision of a predetermined service, comprising:
upper limit acquiring means for acquiring an upper limit of a charge that is entered by a user;
determining means for determining candidates for a service that can be provided within the upper limit of the charge; and
output means for outputting information of the candidates determined by the determining means.

44. An apparatus according to claim 43, further comprising priority acquiring means for acquiring user-designated priority levels, wherein said determining means determines the candidates for a service which can be provided within the upper limit of the charge according to the priority levels.

45. An accounting method for performing accounting on provision of a predetermined service, comprising the steps of:
acquiring an upper limit of a charge that is entered by a user;
determining candidates for a service that can be provided within the upper limit of the charge; and
outputting information of the candidates determined in the determining step.

46. A method according to claim 45, further comprising a step of acquiring user-designated priority levels, wherein in said determining step, the candidates for a service that can be provided within the upper limit of the charge are determined according to the priority levels.

47. A computer-readable memory medium which stores a program for performing accounting on provision of a predetermined service, the program comprising:
an acquiring step of acquiring an upper limit of a charge that is entered by a user;
a determining step of determining candidates for a service that can be provided within the upper limit of the charge; and
an output step of outputting information of the candidates determined in the determining step.

48. A computer-readable memory medium according to claim 47, wherein the program further comprises an acquiring step of acquiring priority levels of set items which specify a setting for printing and which are entered by a user,
wherein the candidates for a service which can be provided within the upper limit of the charge are determined according to the priority levels.

49. An apparatus for providing pay services over a network, comprising:
a detector that detects a request for a designated pay service and an upper limit of an amount to be paid for the designated pay service; and
an output device that outputs information that represents a pay service other than the designated pay service which can be provided within the upper limit of the amount to be paid.

50. An apparatus according to claim 49, further comprising a requesting device that requests provision of one of the designated pay service and the pay service that can be provided within the upper limit.

51. An apparatus according to claim 49, wherein said output device includes a judging device that judges whether a binding service is provided within the upper limit.

52. An apparatus for providing pay services over a network, comprising:
a judging device that judges a charge for a basic service; and
an output device that outputs information which represents a service that can be provided within a payable limit without payment of a charge that will exceed the payable limit according to the judged charge for the basic service.

53. An apparatus according to claim 52, further comprising a requesting device that requests provision of one of the basic service and the service that can be provided within the payable limit without exceeding the payable limit.

54. An apparatus for providing a pay service over a network, comprising:
a detector that detects a request for a designated service and an upper limit of a payable amount for the designated service; and
an output device that outputs information that represents a pay service other than the designated service which can be provided beyond the upper limit of payable amount.

55. An apparatus according to claim 54, further comprising a requesting device that requests provision of one of the designated service and the service that can be provided beyond the upper limit of the payable amount.

56. An apparatus for providing a pay service over a network, comprising:
a judging device that judges a charge for a basic service; and
an output device that outputs information which represents a service that requires payment of an extra charge beyond an upper limit of a payable amount according to the judged charge for the basic service.

57. An apparatus according to claim 56, further comprising a requesting device that requests provision of one of the basic service and the service that requires payment of the extra charge.

58. An apparatus for presenting options for a pay service, comprising:
a detector that detects a setting that requires payment of a charge; and
an option presenting device that presents an option that requires payment of a charge larger than the detected setting and that falls within an upper limit of a payable charge.

59. An apparatus according to claim 58, further comprising a selecting device that selects one of the detected setting and the option.

60. An apparatus according to claim 58, wherein said presenting device presents the option according to a charge required by the detected setting.

61. An accounting system having a service providing apparatus, a data processing apparatus, and an accounting apparatus, said accounting system comprising:
an input device that inputs an upper limit of a charge payable for a requested service;
a determining device that determines candidates for a service which can be provided by said service providing apparatus within an upper limit of the charge; and
a reporting device that reports information of the candidates to said data processing apparatus.

62. An accounting system according to claim 61, wherein said input device inputs priority levels of the requested service and said determining device determines the candidates for a service which can be provided by said service providing apparatus within the upper limit of the charge according to the priority levels.

63. An accounting system according to claim 61, wherein said input device provides an input field on a screen of said data processing apparatus in which the upper limit of the charge is input.

64. An accounting system according to claim 61, wherein said reporting device provides the information of the candidates on a screen of said data processing apparatus so that any of the candidates can be selected.

65. An accounting system according to claim 61, wherein when a charge for a requested service is set by a user and is within the upper limit of the charge, said determining device determines the candidates for the service that can be provided within the upper limit of the charge.

66. An accounting system according to claim 61, wherein the requested service is a service of producing a printout of data.

67. An accounting apparatus for performing accounting on provision of a predetermined service, comprising:
an upper limit acquiring device that acquires an upper limit of a charge that is entered by a user;
a determining device that determines candidates for a service that can be provided within the upper limit of the charge; and
an output device that outputs information of the candidates determined by the determining device.

68. An apparatus according to claim 67, further comprising a priority acquiring device that acquires user-designated priority levels, wherein said determining device determines the candidates for a service which can be provided within the upper limit of the charge according to the priority levels.
